(19) United States
(12) Patent Application Publication
(10) Pub. No.: US 2023/0076822 A1
(43) Pub. Date: Mar. 9, 2023

(54) SYSTEMS AND METHODS FOR MANAGING FEEDBACK FOR MULTICAST TRANSMISSIONS

(71) Applicant: ZTE CORPORATION, Shenzhen (CN)

(72) Inventors: Peng HAO, Shenzhen (CN); Xing LIU, Shenzhen (CN); Xingguang WEI, Shenzhen (CN); Jing SHI, Shenzhen (CN)

(21) Appl. No.: 17/984,851

(22) Filed: Nov. 10, 2022

Related U.S. Application Data
(63) Continuation of application No. PCT/CN2020/090293, filed on May 14, 2020.

(51) Int. Cl. H04W 72/00

(52) U.S. Cl. CPC H04W 72/005

(57) ABSTRACT

A system and method for wireless communications, including receiving, by a wireless communication device from a network, a first Transport Block (TB) via unicast and receiving, by the wireless communication device, an indication information indicating that the first TB received via the unicast is same as a second TB transmitted by the network via multicast.

### CROSS-REFERENCE TO RELATED APPLICATION

This application claims the benefit of priority under 35 U.S.C. § 120 as a continuation of PCT Patent Application No. PCT/CN2020/090293, filed on May 14, 2020, the disclosure of which is incorporated herein by reference in its entirety.

### TECHNICAL FIELD

The disclosure relates generally to wireless communications and, more particularly, to systems and methods for managing feedback for multicast transmissions.

### BACKGROUND

The First Phase Standardization of the 5th Generation Mobile Communication Technology (5G) has already been completed. Employed therein a series of unicast features, specified in New Radio (NR) releases such as but not limited to, Rel-15 and Rel-16. However, no broadcast/multicast feature support has yet been specified.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

In some arrangements, a wireless communication method includes receiving, by a wireless communication device from a network, a first Transport Block (TB) via unicast and receiving, by the wireless communication device from the network, an indication information indicating that the first TB received via the unicast is same as a second TB received from the network via multicast. A TB is received via unicast means that, the received TB is carried on a PUSCH scheduled by a PDCCH, which carries a Downlink Control Information (DCI) with Cyclic Redundancy Check (CRC) scrambled by a UE-specific RNTI, e.g., C-RNTI. A TB is received via multicast means that, the received TB is carried on a PUSCH scheduled by a PDCCH, which carries a DCI with CRC scrambled by a group common RNTI, e.g., G-RNTI, defined for this multicast service.

In some arrangements, a wireless communication apparatus including at least one processor and a memory. The at least one processor is configured to read code from the memory and implement the wireless communication method that includes receiving, from a network, a first TB via unicast and receiving, from the network, an indication information indicating that the first TB received via the unicast is same as a second TB received from the network via multicast.

In some arrangements, a computer program product including a computer-readable program medium code stored thereupon, the code, when executed by at least one processor, causing the at least one processor to implement the wireless communication method that includes receiving, from a network, a first TB via unicast and receiving, from the network, an indication information indicating that the first TB received via the unicast is same as a second TB received from the network via multicast.

In some arrangements, a wireless communication method includes transmitting, by a network to a wireless communication device, a first TB via unicast and indication information and transmitting, by the network to a plurality of wireless communication devices, a second TB via multicast. The plurality of wireless communication devices includes the wireless communication device. The indication information indicates that the first TB transmitted via the unicast is same as the second TB transmitted by the network via the multicast. A TB is transmitted via unicast means that, the transmitted TB is carried on a PUSCH scheduled by a PDCCH, which carries a DCI with CRC scrambled by a UE specific RNTI, e.g., C-RNTI. A TB is transmitted via multicast means that, the transmitted TB is carried on a PUSCH scheduled by a PDCCH, which carries a DCI with CRC scrambled by a group common RNTI, e.g., G-RNTI, defined for this multicast service.

In some arrangements, a wireless communication apparatus including at least one processor and a memory. The at least one processor is configured to read code from the memory and implement the wireless communication method that includes transmitting, to a wireless communication device, a first TB via unicast and indication information and transmitting, to a plurality of wireless communication devices, a second TB via multicast. The plurality of wireless communication devices includes the wireless communication device. The indication information indicates that the first TB transmitted via the unicast is same as the second TB transmitted by the network via the multicast.

In some arrangements, a computer program product including a computer-readable program medium code stored thereupon, the code, when executed by at least one processor, causing the at least one processor to implement the wireless communication method that includes transmitting, to a wireless communication device, a first TB via unicast and indication information and transmitting, to a plurality of wireless communication devices, a second TB via multicast. The plurality of wireless communication devices includes the wireless communication device. The indication information indicates that the first TB transmitted via the unicast is same as the second TB transmitted by the network via the multicast.

The above and other aspects and their embodiments are described in greater detail in the drawings, the descriptions, and the claims.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 is diagram illustrating a slot structure corresponding to an example configuration of monitoring occasions, in accordance with an embodiment of the present disclosure.

FIG. 2 is diagram illustrating a slot structure corresponding to an example configuration of monitoring occasions, in accordance with an embodiment of the present disclosure.

FIG. 3 is diagram illustrating a slot structure corresponding to an example configuration of monitoring occasions, in accordance with an embodiment of the present disclosure.

FIG. 4 is diagram illustrating a slot structure corresponding to an example configuration of monitoring occasions, in accordance with an embodiment of the present disclosure.

FIG. 5 is diagram illustrating a slot structure corresponding to an example configuration of monitoring occasions, in accordance with an embodiment of the present disclosure.

FIG. 6 is diagram illustrating a slot structure corresponding to an example configuration of monitoring occasions, in accordance with an embodiment of the present disclosure.

FIG. 7 is a flowchart diagram illustrating a wireless communication method for managing multicast feedback, according to some embodiments of the present disclosure.

FIG. 8 is a flowchart diagram illustrating a wireless communication method for managing multicast feedback, according to some embodiments of the present disclosure.

FIG. 9A illustrates a block diagram of an example base station, in accordance with some embodiments of the present disclosure; and

FIG. 9B illustrates a block diagram of an example UE, in accordance with some embodiments of the present disclosure.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

Applicant recognizes that broadcast and multicast can improve 5G wireless communication systems, for example, in system efficiency and user experience. Under a multicast mode, the same transmission mechanism can be used by a network node (e.g. a base station) to transmit the same information to a group of User Equipment (UEs) or wireless communication devices. An identification and management method is employed for the UE group corresponding to a type of multicast service. As used herein, the UE group for the type of multicast service can be referred to as a “multicast UE group. ” In some examples, different UEs can experience various network environments (e.g., channel conditions and so on). To improve efficiency of multicast transmissions, UEs experiencing similar network environments are grouped into a same multicast UE group, in some examples. In that regard, the transmission mechanism selected can be matched to the network environment of each UE in the multicast UE group in a corresponding manner. Furthermore, given that the network environment of each UE can change dynamically over time, the management of multicast UE group can also be performed in a dynamical manner, according to various arrangements disclosed herein.

Some embodiments of the present disclosure relate to the manner in which a transmission scheme is determined responsive to a network environment of a UE in a multicast UE group suffering mutation (e.g., responsive to a change in the network environment of the UE in the multicast UE group). For example, Channel Status Information (CSI) measurement results reported by the UE can indicate that a substantially different Pre-coding Matrix Indicator (PMI) or Modulation and Coding Scheme (MCS) is needed for the UE as compared to the PMI and MSC used for other UEs in the same multicast UE group. In that situation, if the network transmits multicast service with a relative conservative transmission scheme by taking into account the needs of the mutational UE, the efficiency of the overall network would degrade. On the other hand, if the network selects a transmission scheme according to the needs of the majority of UEs in the multicast UE group (without considering the needs of the mutational UE), the network performance experienced by the mutational UE can be hardly guaranteed, leading to user experience degradation for the mutational UE.

Multicast service can be carried on a Physical Downlink Shared Channel (PDSCH) as scheduled via a Physical Downlink Control Channel (PDCCH). The PDSCH and the PDCCH are referred to as “multicast service PDSCH” and “multicast service PDCCH,” respectively. The multicast service PDCCH carries a DCI format with CRC scrambled by corresponding Radio Network Temporary Identifier (RNTI), which is configured via Radio Resource Control (RRC) signaling. Monitoring information of multicast service PDCCH, such as but not limited to, search space set configuration and Control Resource Set (CORESET) configuration, can be referred to as multicast control information. The multicast control information can be indicated in system information, which for example can be carried on a PDSCH scheduled via a PDCCH. The PDCCH is scrambled via System Information RNTI (SI-RNTI). Alternatively, the multicast control information can be carried on a PDSCH scheduled via a PDCCH, which is scrambled by a fixed RNTI for multicast specified in the specification or a dedicated RNTI configured via RRC signaling for this multicast service. The PDSCH and PDCCH used to respectively carry and schedule the multicast control information can be referred to as “multicast control PDSCH” and “multicast control PDCCH,” respectively. The CORESET for multicast service PDCCH and multicast control PDCCH can be configured separately, or share a same CORESET configuration. The search space set of multicast service PDCCH and multicast control PDCCH can be configured separately, or share a same search space set configuration (e.g., configured jointly).

In a wireless communication system, a CORESET includes one or more resource blocks (RBs) in the frequency domain and one or more Orthogonal Frequency Division Multiplexing (OFDM) symbols in the time domain. One or more PDCCH candidates are transmitted in a CORESET. The configuration parameters of a CORESET are configured by the network for a UE. Examples of the configuration parameters include but are not limited to, an index of the set (e.g., a CORESET index), a frequency domain resource, a duration of the set (e.g., a CORESET duration), and so on. One or more CORESETs may be configured for a UE, for the UE to monitor PDCCH.

In some examples, UEs receiving the same type of multicast service can be defined as a multicast UE group. For each UE in a multicast group, a base station (e.g., gNB) transmits the same information using the same transmission mechanism.

In a wireless communication system, one or more search space sets can be configured by a network for a UE. The configuration parameters of a search space set include but are not limited to, a search space index, an associated CORESET index (that is associated with the search space index), a PDCCH monitoring periodicity, a PDCCH monitoring offset, a search space duration, a PDCCH monitoring pattern within a slot, search space type, and so on. In some implementations, there are two types of search spaces, a UE-Specific Search Space (USS) and a Common Search Space (CSS). A search space type can further indicate one or more Downlink Control Information (DCI) formats that a UE monitors. A search space set is associated with (maps to) a given CORESET. PDCCH monitoring periodicity and PDCCH monitoring offset indicate slots in which a UE needs to monitor PDCCH. According to search space set configurations and the associated CORESET configurations, a UE can monitor for PDCCH with DCI formats indicated by the search space type, on the resources indicated by the CORESET, and in the slots indicated by the PDCCH monitoring periodicity and PDCCH monitoring offset.

The arrangements disclosed herein relate to transmit transmission of a TB in PDSCH scheduled by a unicast PDCCH. In some examples, indication is provided to indicate that a multicast TB is scheduled by the unicast PDCCH. Using the various indication methods disclosed herein, the UE can determine that the multicast TB has been transmitted in unicast mode and avoid NACK-only feedback for the multicast TB transmitted in multicast mode (if the multicast TB is not received in the multicast mode). Accordingly, unnecessary re-transmission of the multicast TB though the multicast mode can be avoided, improving efficiency of the network in multicast transmissions.

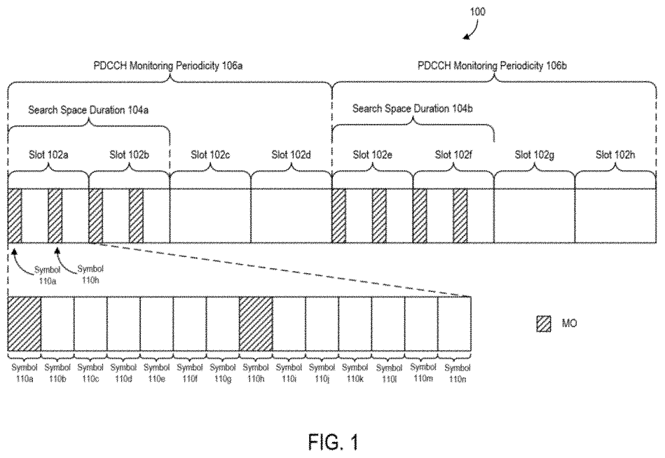

FIG. 1 is diagram illustrating a slot structure corresponding to an example configuration 100 of PDCCH monitoring occasions, according to various embodiments. Referring to FIG. 1, the configuration 100 corresponds to slots 102a, 102b, 102c, 102d, 102e, 102f, 102g, and 102h (collectively the slots 102a-102h). A PDCCH monitoring periodicity is a periodicity by which a UE monitors PDCCH. In the configuration 100, the PDCCH monitoring periodicity is 4 slots. That is, the slots 102a-102d are in a PDCCH monitoring periodicity 106a, and the slots 102e-102h are in a PDCCH monitoring periodicity 106b. The PDCCH monitoring offset in the configuration 100 is 0 (e.g., no offset).

A search space duration in the configuration 100 is 2 slots. As shown, within the PDCCH monitoring periodicity 106a, a search space duration 104a includes slots 102a and 102b. Within the PDCCH monitoring periodicity 106b, a search space duration 104b includes slots 102e and 102f In the configuration 100, 2 PDCCH Monitoring Occasions (MOs) are configured in a given slot within the search duration 104a or 104b. For example, the slot 102a includes 14 OFDM symbols 110a, 110b, 110c, 110d, 110e, 110f, 110g, 110h, 110i, 110j, 110k, 110l, 110m, and 110n (collectively symbols 110a-110n). Symbols 110a and 110h are configured as MOs. Therefore, there are 4 total MOs within each PDCCH monitoring period. For instance, the symbols 110a and 110h as well as two additional OFDM symbols in the slot 102b are within PDCCH monitoring periodicity 106a. Two OFDM symbols in each of slots 102e and 102f are within PDCCH monitoring periodicity 106b. In each of MO, the UE monitors PDCCH using one resource configured via CORESET.

In some examples of a wireless communication system, there can be one or more PDCCH candidates in one search space. Each PDCCH candidate is identified by a PDCCH candidate index. A network (e.g., one or more base stations) can transmit control information to a UE or a group (e.g., a multicast UE group) of UEs. A PDCCH can transmit the control information using units of data such as one or more Control-Channel Elements (CCEs). Each CCE is identified by a CCE index.

In some cases, with a network environment, one UE in a multicast UE group may suffers mutation. For example, the CSI measurement results reported by the UE may indicate that a PMI or MCS substantially different from the PMI(s) and MSC(s) used or needed for other UEs in the same multicast UE group. This means that the signal strength of the connection between the mutational UE and the network (e.g., one or more base stations) as measured by the mutational UE is significantly better or worse than the signal strengths of the connections between other UEs in the group and the network. In such a situation, various implementations disclosed herein can be used to determine transmission scheme for multicast service transmission.

Examples of a multicast transmission scheme include but are not limited to, MCS, precoding matrix, and so on. In some embodiments, a multicast transmission scheme for transmitting a multicast Transmission Block (TB) can be determined according to feedback from a majority of UEs in the multicast UE group. Examples of the feedback include but are not limited to, Channel Quality Indicator (CQI), Rank Indication (RI), PMI, and so on. For remaining UEs (the UEs that are not the mutational UE) in the same multicast UE group, the network can transmit the same multicast TB though unicast mode, for example, by scheduling a PDSCH carrying the same multicast TB though an unicast PDCCH. In the unicast mode, the transmission scheme can be selected to accurately correspond to the network environment (as reflected by the feedback information) experienced by a specific UE. In that regard, network performance of the UE can be guaranteed.

In some arrangements, a Negative-Acknowledgement (NACK)-only feedback mechanism can be employed to support multicast transmission Hybrid Automatic Repeat Request (HARQ)-Acknowledgement (ACK) feedback. In the NACK-only feedback mechanism, a group of UEs share a same resource for HARQ-ACK feedback, and a UE in the group needs to provide feedback in that resource only in response to determining that the UE has not received the multicast TB correctly.

In some examples in which a UE receiving a same multicast TB from both unicast mode and multicast mode, the UE may not correctly receive the multicast TB though multicast mode, and a feedback message is sent on the NACK-only feedback resource. However, the UE may have correctly received the multicast TB though unicast already. In such examples, the feedback from the UE may lead to an extra retransmission of the multicast TB though multicast mode, thus wasting network resources.

To conserve network resources, the TB carried on PDSCH scheduled by unicast PDCCH can be indicated to be the same as the multicast TB transmitted in the multicast mode using each example indication method disclosed herein. In some embodiments, a network (e.g., a base station) transmits a multicast TB in a PDSCH scheduled by a unicast PDCCH. In particular, the network can indicate the multicast TB that is scheduled by unicast PDCCH. By using the indication methods disclosed herein, the UE can identify that the received multicast TB has been transmitted in unicast mode and avoid providing NACK-only feedback for the same multicast TB transmitted in multicast mode. In that regard, re-transmission of the multicast TB though the multicast mode can be avoided, thus improving network efficiency for transmitting multicast service.

In some cases, a normal HARQ-ACK feedback mechanism can be employed for multicast transmission. In the normal NACK-ACK feedback mechanism, each UE is configured one or more separate feedback resources, on which both positive feedback (e.g., ACK) and negative feedback (e.g., NACK) can be transmitted. A UE provides positive feedback in that resource in response to determining that the UE has received the multicast TB correctly. On the other hand, a UE provides negative feedback in that resource in response to determining that the UE has not received the multicast TB correctly.

In some examples in which a same multicast TB is transmitted to the UE in both unicast mode and multicast modes, the UE may not correctly receive the multicast TB though the multicast mode and sends a negative feedback message on the feedback resource. In this case, the UE may have correctly received the multicast TB though the unicast mode already. In such examples, the feedback from the UE may lead to an extra retransmission of the multicast TB though the multicast mode, thus wasting network resources.

To conserve network resources, the TB carried on PDSCH scheduled by unicast PDCCH can be indicated to be the same as the multicast TB transmitted in the multicast mode using each example indication method disclosed herein. In some embodiments, a network (e.g., a base station) transmits a multicast TB in a PDSCH scheduled by a unicast PDCCH. In particular, the network can indicate the multicast TB that is scheduled by unicast PDCCH. By using the indication methods disclosed herein, the UE can identify that the received multicast TB has been transmitted in unicast mode and avoid providing negative feedback for the same multicast TB transmitted in multicast mode. In that regard, re-transmission of the multicast TB though the multicast mode can be avoided, thus improving network efficiency for transmitting multicast service. Alternatively, the network can also ignore the negative feedback from the UE for the multicast TB has been transmitted via unicast instead of transmitting the indication information.

In some embodiments, a first indication method can be employed for indicating multicast TB transmitted in unicast mode. The management of HARQ processing is independent for unicast mode and multicast mode. In other words, HARQ processing is managed separately for the unicast mode and the multicast mode. A HARQ Processing Number (HPN) field in a PDCCH can be used to indicate a HPN for scheduling a TB. In one example, the HPN field occupies 4 bits, and each bit provides binary information (e.g., 0 or 1). That is, HPN 0000˜1111 are configured to be used in unicast mode. The same range of HPN can also be concurrently configured to be used in multicast mode.

In some embodiments, indication information can be a HPN used in a multicast PDCCH for scheduling the multicast TB, referred to as a HPN for multicast TB. The indication information can be indicated via signaling (e.g., a Medium Access Control (MAC) Control Element (CE)) carried on a PDSCH scheduled by a unicast PDCCH. The UE can identify that the TB carried on the same PDSCH is the same as the multicast TB corresponding to the same HPN. In other words, both the TB and the indication information (e.g., the HPN for the multicast TB) are carried on a same unicast PDSCH.

Illustrating with an example, a network (e.g., one or more base stations) transmits a multicast TB to UEs in a multicast UE group via the multicast mode. The network further transmits the multicast TB to one (e.g., a first UE) of the UEs in the multicast UE group, via the unicast mode. The network sets the HPN for the multicast TB is set to 0000 in a multicast PDCCH scheduling the multicast TB. The network transmits a MAC CE containing the HPN (0000) for the multicast TB on a PDSCH scheduled by a unicast PDCCH. After the first UE receives the PDSCH, the UE can identify that the TB carried on the same PDSCH is the multicast TB corresponding to HPN 0000. In the NACK-only feedback mechanism in which only NACK needs to be provided to the base station, the first UE refrains from providing feedback for the multicast TB transmitted in the multicast mode, given that the multicast TB identified by the same HPN (0000) has been received via unicast even though the multicast TB has not been received via multicast. Thus, the network can determine whether to retransmit the multicast TB via the multicast mode based on feedback from one or more other UEs in the multicast UE group, where the network sent the multicast TB to those other UEs via only the multicast mode. In particular, the network can select a multicast transmission scheme for transmitting additional multicast TBs according to feedback from a majority of UEs in the multicast UE group without considering the first UE, with may be the mutational UE, given that the first UE refrains from sending negative feedback (NACK) indicating to the network that the wireless communication device fails to correctly receive the second TB via the multicast.

In some embodiments, New Data Indication (NDI) in unicast PDCCH for scheduling multicast TB is set to a “toggled” value comparing to a value of the NDI in the last (immediately preceding) unicast PDCCH with the same HPN.

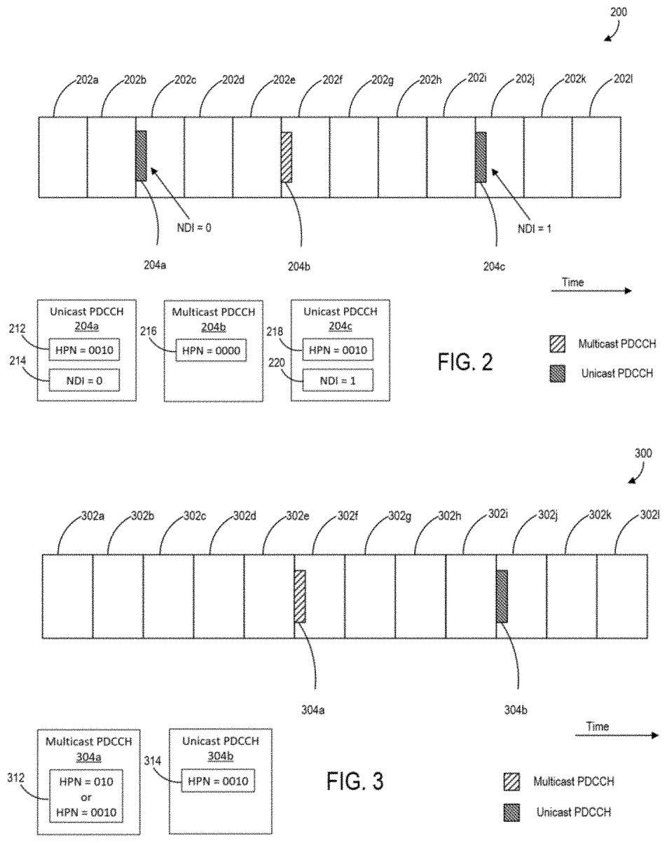

FIG. 2 is a diagram of a slot structure 200 illustrating multicast and unicast downlink control channels, according to various embodiments. Referring to FIGS. 1 and 2, the slot structure 200 is a downlink slot structure 200 by which a UE received data in downlink from a network (e.g., one or more base stations). The slot structure 200 includes slots 202a, 202b, 202c, 202e, 202f, 202g, 202h, 202i, 202j, 202k, and 202l (collectively slots 202a-202l). The UE monitors a unicast service PDCCH MO in the slot 202c and receives a unicast PDCCH 204a in the unicast service PDCCH MO. The UE monitors a unicast service PDCCH MO in the slot 202j and receives a unicast PDCCH 204c in the unicast service PDCCH MO. The UE monitors a multicast service PDCCH MO in the slot 202f and receives a multicast PDCCH 204b in the multicast service PDCCH MO.

The network uses the multicast PDCCH 204b to schedule transmission of a multicast TB to the UE. The network sets the value of HPN in a HPN field 216 the multicast PDCCH 204b to be 0000, for example. The network uses the unicast PDCCH 204c to schedule transmission of the same multicast TB to the UE, for example, in the situation in which the UE is a mutational UE. The network sets the value of HPN in a HPN field 218 the unicast PDCCH 204c to be 0010, for example.

As shown, the unicast PDCCH that the network transmits to the UE closest in time before the unicast PDCCH 204c is the unicast PDCCH 204a. The network uses the unicast PDCCH 204a to schedule transmission of a unicast TB. The unicast PDCCH 204a is the closest unicast PDCCH to the unicast PDCCH 204c that has the same HPN (e.g., 0010). The network sets the HPN in a HPN field 212 of the unicast PDCCH 204c to be 0010. The network sets the NDI in an NDI field 214 of the unicast PDCCH 204a to be 0. Furthermore, the network sets the NDI in an NDI field 220 of the unicast PDCCH 204c to be 1, that is, a toggled value of 0. The NDI for the unicast PDCCH 204c is different from the NDI for the unicast PDCCH 204a. The NDI in the unicast PDCCH 204c being be 1 (a toggled value of 0) indicates to the UE that the TB being scheduled using the unicast PDCCH 204c is new data, such that the UE does not combine the unicast TB scheduled using the unicast PDCCH 204a with the TB (which is in fact a multicast TB) scheduled using unicast PDCCH 204c, even if the HPN for both the unicast PDCCH 204a and the unicast PDCCH 204c are the same, e.g., 0010. In other words, the unicast PDCCH 204c includes indication (the NDI) that the unicast PDCCH 204c carries new data separate from data carried by the unicast PDCCH 204a, such that the data from the unicast PDCCHs 204a and 204c cannot be combined.

Alternatively or in addition, the indication information (e.g., the HPN for the multicast TB) can be carried in a unicast PDCCH that schedules the unicast PDSCH that carries the multicast TB. A field can be defined in the unicast PDCCH for indicating HPN for the multicast TB. Responsive to receiving the unicast PDCCH with a value of the field, e.g., HPN for the multicast TB (0010) that is the same as the HPN value (0010) in the multicast PDCCH, the UE determines that the TB carried on the PDSCH scheduled by the unicast PDCCH is the same as the multicast TB carried on the PDSCH scheduled by the multicast PDCCH.

In some embodiments, a second indication method can be employed for indicating multicast TB transmitted in unicast mode. The management of HARQ processing is independent for unicast mode and multicast mode. In other words, HARQ processing is managed separately for the unicast mode and the multicast mode. A HPN field in a PDCCH can be used to indicate a HPN for scheduling a TB. In the second indication method, the value range of HPNs for the multicast mode is a subset of value range of HPNs for the unicast mode. In other words, the HPN values available to be used in the multicast mode is the same as or equivalent to corresponding ones (some but not all) of the HPN values available to be used in the unicast mode. The HPN field value ranges available to be used in multicast mode and unicast mode can be configured via RRC signaling or defined in the specification.

In one example, the HPN field for the multicast mode and the HPN field for the unicast mode each occupies 4 bits. A HPN value range of 0000˜1111 is configured to be used in the unicast mode. A HPN value range of 0000˜0111 is configured to be used in the multicast mode. In that regard, each of the HPN value range of 0000˜0111 used in multicast PDCCH is equivalent to one of the HPN value range of 0000˜1111 used in unicast PDCCH for identifying a multicast TB. That is, 0000 in multicast PDCCH is equivalent to 0000 in unicast PDCCH, 0001 in multicast PDCCH is equivalent to 0001 in unicast PDCCH, . . . , 0111 in multicast PDCCH is equivalent to 0111 in unicast PDCCH.

In another example, the bitwidth of HPN field for multicast mode is less than the bitwidth of HPN field for unicast mode. For example, the HPN field for the multicast mode occupies 3 bits, and the HPN field for the unicast mode occupies 4 bits. A HPN value range of 0000˜1111 is configured to be used in the unicast mode. A HPN value range of 000˜111 is configured to be used in multicast mode. In that regard, each of the HPN value range of 000˜111 used in multicast PDCCH is equivalent to a corresponding one of the HPN value range of 0000 1111 used in unicast PDCCH for identifying a multicast TB. That is, 000 in multicast PDCCH is equivalent to 0000 in unicast PDCCH, 001 in multicast PDCCH is equivalent to 0001 in unicast PDCCH, 111 in multicast PDCCH is equivalent to 0111 in unicast PDCCH.

In some embodiments, the indication information can be a HPN used in multicast PDCCH for scheduling the multicast TB, referred to as a HPN for multicast TB. The indication information (e.g., the HPN for the multicast TB) can be indicated by a HPN field in a unicast PDCCH that schedules the unicast PDSCH that carries the multicast TB. The HPN field can be defined in the unicast PDCCH for indicating HPN for the multicast TB. The UE can identify that the TB carried on the PDSCH (scheduled by the unicast PDCCH) is the same as the multicast TB scheduled by a multicast PDCCH having the same HPN. For example, a unicast PDCCH having a HPN 0000 schedules a multicast TB that is the same as a multicast TB scheduled by a multicast PDCCH having HPN 000 or 0000.

In some embodiments, given that the value range of HPN for the multicast mode is a subset of value range of HPN for the unicast mode (the value range of HPN for the unicast mode is greater than the value range of HPN for the multicast mode), some but not all (e.g., a first portion) of the value range of HPN for the unicast mode can be configured for scheduling a unicast PDSCH carrying a multicast TB while other values (e.g., a second portion of the value range of the HPN for the unicast mode) can be configured for schedule a unicast PDSCH carrying a unicast TB. As an example, HPN values of 0000˜0111 in the unicast PDCCH can be used for scheduling a PDSCH carrying a multicast TB, and HPN values of 1000˜1111 in the unicast PDCCH can be used for scheduling a PDSCH carrying a unicast TB.

FIG. 3 is a diagram of a slot structure 300 illustrating multicast and unicast downlink control channels, according to various embodiments. Referring to FIGS. 1 and 3, the slot structure 300 is a downlink slot structure 300 by which a UE received data in downlink from a network (e.g., one or more base stations). The slot structure 300 includes slots 302a, 302b, 302c, 302e, 302f, 302g, 302h, 302i, 302j, 302k, and 3021 (collectively slots 302a-302l). The UE monitors a multicast service PDCCH MO in the slot 302f and receives a multicast PDCCH 304a in the multicast service PDCCH MO. The UE monitors a unicast service PDCCH MO in the slot 302j and receives a unicast PDCCH 304b in the unicast service PDCCH MO.

The network uses the multicast PDCCH 304a to schedule transmission of a multicast TB to the UE. The network sets the value of HPN in an HPN field 312 of the multicast PDCCH 304a to be 010 or 0010, for example. The network uses the unicast PDCCH 304b to schedule transmission of the same multicast TB to the UE, for example, in the situation in which the UE is a mutational UE. The network sets the value of HPN in an HPN field 313 of the unicast PDCCH 304b to be 0010, for example.

Responsive to receiving the unicast PDCCH 304b with a HPN value (0010) that is the same as or equivalent to the HPN value (010 or 0010) in the multicast PDCCH 304a, the UE determines that the TB carried on the PDSCH scheduled by the unicast PDCCH 304b is the same as the multicast TB carried on the PDSCH scheduled by the multicast PDCCH 304a.

In some embodiments, a third indication method can be employed for indicating multicast TB transmitted in unicast mode. A HPN field in a PDCCH can be used to indicate a HPN for scheduling a TB. In the third indication method, the value range of HPNs for the multicast mode and the value range of HPNs for the unicast mode are different.

In one example, the HPN field for the multicast mode and the HPN field for the unicast mode each occupies 4 bits. A HPN value range of 0000˜0111 is configured to be used in the unicast mode. A HPN value range of 1000˜1111 is configured to be used in the multicast mode. In other words, the HPN values available to be used for scheduling a multicast TB is different from and do not overlap with any of the HPN values available to be used for scheduling a multicast TB.

In some embodiments, the indication information can be a HPN used in multicast PDCCH for scheduling the multicast TB, referred to as a HPN for multicast TB. The indication information (e.g., the HPN for the multicast TB) can be indicated by a HPN field in a unicast PDCCH that schedules the unicast PDSCH that carries the multicast TB. The HPN field can be defined in the unicast PDCCH for indicating HPN for the multicast TB. The UE can determine that the TB carried on the PDSCH (scheduled by the unicast PDCCH) is the same as the multicast TB scheduled by a multicast PDCCH having the same HPN. For example, a unicast PDCCH having a HPN 0000 schedules a multicast TB that is the same as a multicast TB scheduled by a multicast PDCCH having HPN 0000.

In some examples, the value range of HPN (e.g., 0000˜0111) configured for unicast PDCCH is used only for scheduling PDSCHs carrying unicast TBs. On the other hand, given that the HPN field for unicast is 4 bits, at least a portion of the remaining values of HPN, e.g., the value range of HPN 1000˜1111 (referred to as a remaining value range of the HPN that is not configured for carrying unicast TBs) in a unicast PDCCH can be configured for scheduling a multicast TB. In that regard, each of the HPN value range of 1000˜1111 used in multicast PDCCH is equivalent to one of the HPN value range of 1000˜1111 used in unicast PDCCH for identifying a multicast TB. That is, 1000 in multicast PDCCH is equivalent to 1000 in unicast PDCCH, 1001 in multicast PDCCH is equivalent to 1001 in unicast PDCCH, . . . , 1111 in multicast PDCCH is equivalent to 1111 in unicast PDCCH. The HPN field ranges for a multicast TB and an unicast TB scheduling can be configured via RRC signaling or defined in the specification.

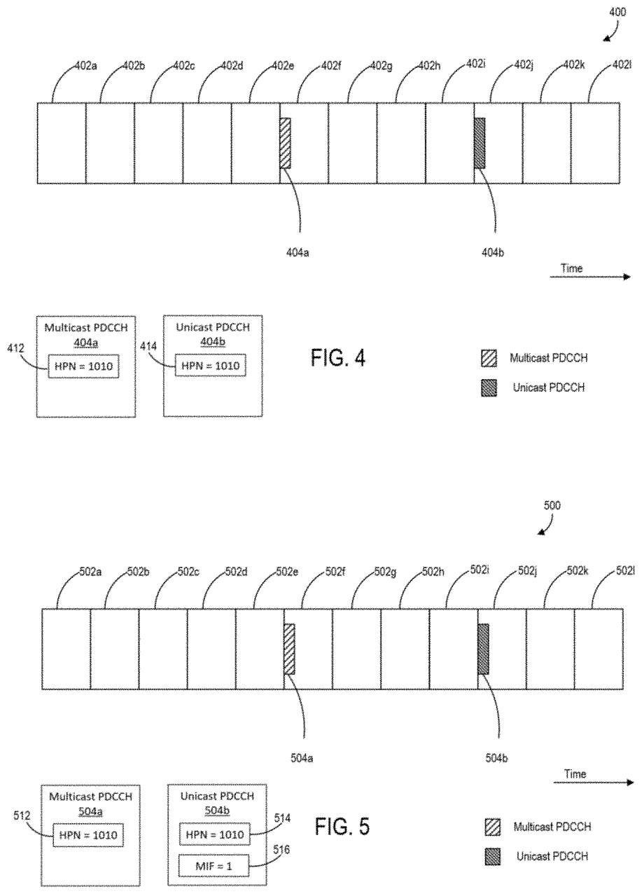

FIG. 4 is a diagram of a slot structure 400 illustrating multicast and unicast downlink control channels, according to various embodiments. Referring to FIGS. 1 and 4, the slot structure 400 is a downlink slot structure 400 by which a UE received data in downlink from a network (e.g., one or more base stations). The slot structure 400 includes slots 402a, 402b, 402c, 402e, 402f, 402g, 402h, 402i, 402j, 402k, and 402l (collectively slots 402a-402l). The UE monitors a multicast service PDCCH MO in the slot 402f and receives a multicast PDCCH 404a in the multicast service PDCCH MO. The UE monitors a unicast service PDCCH MO in the slot 402j and receives a unicast PDCCH 404b in the unicast service PDCCH MO.

The network uses the multicast PDCCH 404a to schedule transmission of a multicast TB to the UE. The network sets the value of HPN in an HPN filed 412 of the multicast PDCCH 404a to be 1010, for example. The network uses the unicast PDCCH 404b to schedule transmission of the same multicast TB to the UE, for example, in the situation in which the UE is a mutational UE. The network sets the value of HPN in an HPN filed 414 of the unicast PDCCH 404b to be 1010. In the example shown in FIG. 4, the value range of HPNs configured to be used by the multicast downlink control channel for scheduling PDSCHs carrying unicast TBs is 0000˜0111.

Responsive to receiving the unicast PDCCH 404b with a HPN value (1010) within the remaining value range of 1000˜1111 that is the same as or equivalent to the HPN value (1010) in the multicast PDCCH 404a, the UE determines that the TB carried on the PDSCH scheduled by the unicast PDCCH 404b is the same as the multicast TB carried on the PDSCH scheduled by the multicast PDCCH 404a.

In some embodiments, a fourth indication method can be employed for indicating multicast TB transmitted in unicast mode. The management of HARQ processing is independent for unicast mode and multicast mode. In other words, HARQ processing is managed separately for the unicast mode and the multicast mode. A HPN field in a PDCCH can be used to indicate a HPN for scheduling a TB. In one example, the HPN field occupies 4 bits, and each bit provides binary information (e.g., 0 or 1). That is, HPN 0000˜1111 are configured to be used in unicast mode. The same range of HPN can also be concurrently configured to be used in multicast mode.

In some embodiments, in addition to the HPN field (e.g., 4 bits), a unicast PDCCH can include a multicast indication field (e.g., 1 bit) that indicates whether the unicast PDCCH is scheduling a unicast TB or a multicast TB. For example, the multicast indication field being a first value (e.g., 0) indicates that the unicast PDCCH schedules a unicast TB (e.g., the HPN field is for a unicast TB). The multicast indication field being a second value (e.g., 1) indicates that the unicast PDCCH schedules a multicast TB (e.g., the HPN field is for a multicast TB). In that regard, in the example in which the multicast indication field indicates that the unicast PDCCH schedules a multicast TB, the HPN field in the unicast PDCCH further identifies the multicast TB that the unicast PDCCH is used to schedule. The TB scheduled by the unicast PDCCH is the same as the multicast TB scheduled by a multicast PDCCH with the same HPN.

FIG. 5 is a diagram of a slot structure 500 illustrating multicast and unicast downlink control channels, according to various embodiments. Referring to FIGS. 1 and 5, the slot structure 500 is a downlink slot structure 500 by which a UE received data in downlink from a network (e.g., one or more base stations). The slot structure 500 includes slots 502a, 502b, 502c, 502e, 502f, 502g, 502h, 502i, 502j, 502k, and 502l (collectively slots 502a-502l). The UE monitors a multicast service PDCCH MO in the slot 502f and receives a multicast PDCCH 504a in the multicast service PDCCH MO. The UE monitors a unicast service PDCCH MO in the slot 502j and receives a unicast PDCCH 504b in the unicast service PDCCH MO.

The network uses the multicast PDCCH 504a to schedule transmission of a multicast TB to the UE. The network sets the value of HPN in an HPN field 512 the multicast PDCCH 504a to be 1010, for example. The network uses the unicast PDCCH 504b to schedule transmission of the same multicast TB to the UE, for example, in the situation in which the UE is a mutational UE. The network sets the value of HPN (in a HPN field 514) in the unicast PDCCH 504b to be 1010 and a multicast indication field (MIF) 516 in the unicast PDCCH 504b to be the second value (e.g., 1).

Responsive to receiving the unicast PDCCH 504b with the multicast indication field 516 to be the second value, the UE determines that the TB carried on the PDSCH scheduled by the unicast PDCCH 504b is a multicast TB (and not a unicast TB) that is the same as the multicast TB carried on the PDSCH scheduled by the multicast PDCCH 504a, given that the HPN values for both the multicast PDCCH 504a and the unicast PDCCH 504b are the same (e.g., 1010).

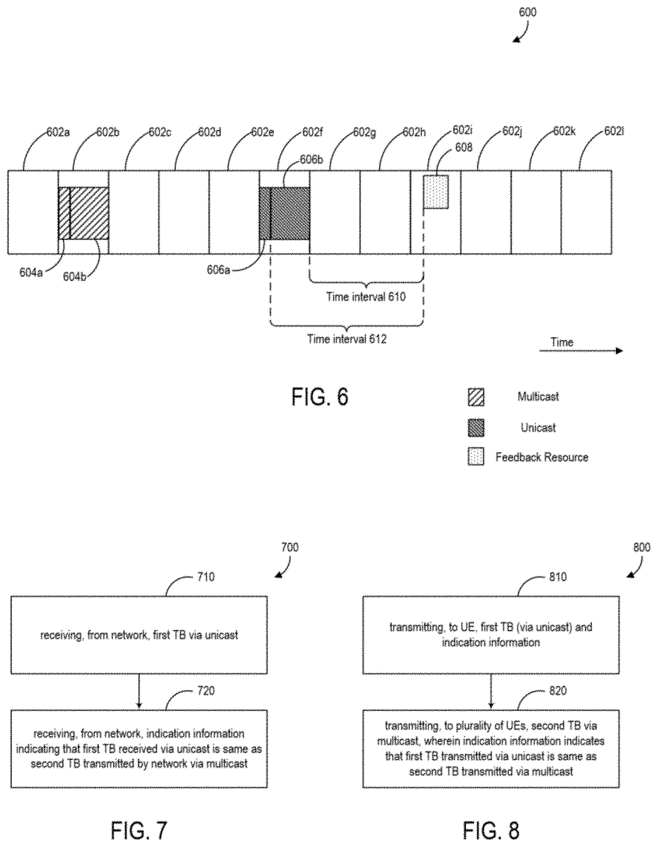

As described herein, in the first, second, third, and fourth indication methods, the indication information (indicating that a multicast TB is carried on a unicast PDSCH) is carried on a unicast PDCCH that schedules the unicast PDSCH. FIG. 6 is a diagram of a slot structure 600 illustrating multicast and unicast downlink control channels, according to various embodiments. Referring to FIGS. 1-6, the slot structure 600 includes slots 602a, 602b, 602c, 602e, 602f, 602g, 602h, 602i, 602j, 602k, and 602l (collectively slots 602a-602l). The UE monitors a multicast service PDCCH MO in the slot 602a and receives a multicast PDCCH 604a in the multicast service PDCCH MO. The network uses the multicast PDCCH 604a to schedule a multicast PDSCH 604b that carries a multicast TB. As show, the multicast PDSCH 604b begins when the multicast PDCCH 604a ends. In some examples, the UE fails to receive the multicast PDSCH 604b.

A feedback resource 608 corresponds to the multicast PDSCH 604b. That is, the UE can transmit feedback on the feedback resource 608 to the network. In particular, in a NACK-only feedback mechanism, in response to the UE determining that the multicast PDSCH 604b scheduled by the multicast PDCCH 604a is not received correctly, the UE transmits a NACK-only feedback on the feedback resource 608 to the network, to notify the network that the UE has not received the multicast PDSCH 604b.

The UE monitors a unicast service PDCCH MO in the slot 602f and receives a unicast PDCCH 606a in the unicast service PDCCH MO. The network uses the unicast PDCCH 606a to schedule a unicast PDSCH 606b that carries a multicast TB. As show, the unicast PDSCH 606b begins when the unicast PDCCH 606a ends. The unicast PDCCH 606a or the unicast PDSCH 606b can include the indication information to notify the UE that the unicast PDSCH 606b is carrying the same multicast TB as that carried by the multicast PDSCH 604b, as described.

In the examples in which the unicast PDCCH 606a carries the indication information to notify the UE that the unicast PDSCH 606b is carrying the same multicast TB as that carried by the multicast PDSCH 604b, a time interval 612 is defined to be a time interval between the ending point of a Control Resource Set (CORESET) of the unicast PDCCH 606a used for multicast TB scheduling (e.g., for scheduling the multicast TB) and the starting point of the feedback resource 608 (e.g., a NACK-only feedback resource) corresponding to the multicast TB (e.g., that carried in the multicast PDSCH 604b) in the multicast mode. A value defining a threshold length of the time interval 612 is N symbols. The value of N can be defined in the specification or configured though RRC signaling according to Sub-Carrier Spacing (SCS). For example, N=5 symbols for SCS=15 kHz, N=5.5 symbols for SCS=30 kHz, . . . , and so on. The SCS used for determining the value of number N can be the SCS of the unicast PDCCH 606a or the SCS of the feedback resource 608, in some examples. In some examples, the number N can be defined based on the smaller one of the SCS of the unicast PDCCH 606a and the SCS of the feedback resource 608. In some examples, the UE expects that the time interval 612 between the ending point of the CORESET of the unicast PDCCH 606a for multicast TB scheduling and the starting point of NACK-only feedback resource 608 corresponding to the multicast TB in multicast mode to be greater than a threshold (e.g., N symbols).

In the examples in which the unicast PDSCH 606b carries the indication information to notify the UE that the unicast PDSCH 606b is carrying the same multicast TB as that carried by the multicast PDSCH 604b, a time interval 610 is defined to be a time interval between the ending point of the unicast PDSCH 606b (carrying a multicast TB scheduling, e.g., the indication information) scheduled by unicast PDCCH 606a and the starting point of the feedback resource 608 (e.g., a NACK-only feedback resource) corresponding to the multicast TB in multicast mode. A value defining a threshold length of the time interval 610 is M symbols. The value of M can be defined in the specification or configured though RRC signaling according to SCS. For example, N=2 symbols for SCS=15 kHz, N=3 symbols for SCS=30 kHz, . . . , and so on. The SCS used for determining the value of number M can be the SCS of the unicast PDSCH 606b or the SCS of the feedback resource 608, in some examples. In some examples, the number M can be defined based on the smaller one of the SCS of the unicast PDSCH 606b and the SCS of the feedback resource 608. In some examples, the UE expects that the time interval 610 between the ending point of the unicast PDSCH 606b carrying a multicast TB scheduling scheduled for unicast PDCCH and the starting point of NACK-only feedback resource 608 corresponding to the multicast TB in multicast mode is greater than a threshold (e.g., M symbols).

FIG. 7 is a flowchart diagram illustrating a wireless communication method 700 for managing multicast feedback, according to some embodiments of the present disclosure. Referring to FIGS. 1-7, the wireless communication method 700 can be implemented by a UE (e.g., a wireless communication device).

At 710, the UE receives, from a network, a first TB via unicast. At 720, the UE receives, from the network, indication information indicating that the first TB received via the unicast is same as a second TB transmitted by the network via multicast. In some examples, the first TB and the indication information are received before the second TB. In some examples, the first TB and the indication information are received after the second TB, as shown in FIGS. 2-6.

In some examples, in response to receiving the first TB and the indication information or in response to receiving the indication information, the UE refrains from providing negative feedback to the network. The negative feedback indicates to the network that the UE has failed to correctly receive the second TB via the multicast. That is, regardless of whether the UE receives the second TB, the UE determining that the second TB is received by in response to receiving the first TB and the indication information or in response to receiving indication information. In some embodiments, the first TB and the second TB are a same TB. The negative feedback is a NACK feedback.

In some embodiments, according to the first indication method, the indication information is a HPN used in a multicast downlink control channel for scheduling the second TB. The first TB is received in a unicast downlink shared channel of the unicast. A unicast downlink control channel is used to schedule the first TB in a unicast downlink shared channel.

In some embodiments, according to the first indication method, the indication information is received from the network via signaling on a unicast downlink shared channel scheduled by a unicast downlink control channel. As disclosed in further detail, a time interval between an ending point (e.g., an end of a last symbol) of the unicast downlink shared channel and a starting point (e.g., a start symbol) of a feedback resource corresponding to the second TB is greater than a threshold.

In some embodiments, according to the first, second, third, or fourth indication method, the indication information is received from the network in a unicast downlink control channel used to schedule the first TB in a unicast downlink shared channel. As disclosed in further detail, a time interval between an ending point (e.g., an end of a last symbol) of a CORESET for the unicast downlink control channel and a starting point (e.g., a start symbol) of a feedback resource corresponding to the second TB is greater than a threshold.

In some embodiments, according to the second indication method, the indication information is a HPN used in a multicast downlink control channel for scheduling the second TB. The multicast downlink control channel is defined (e.g., defined in the specification or signed using RRC signaling) to use a first value range of HPNs in multicast mode. A unicast downlink control channel is defined (e.g., defined in the specification or signed using RRC signaling) to use a second value range of HPNs in unicast mode. The first value range is a subset of the second value range. In some embodiments, each value of a first portion of the second value range of HPNs is used to schedule a unicast downlink physical channel carrying a multicast TB. Each value of a second portion of the second value range of HPNs is used to schedule a unicast downlink physical channel carrying a unicast TB.

In some embodiments, according to the third indication method, the indication information is a HPN used in a multicast downlink control channel for scheduling the second TB. The multicast downlink control channel is defined (e.g., defined in the specification or signed using RRC signaling) to use a first value range of HPNs in multicast mode. A unicast downlink control channel is defined (e.g., defined in the specification or signed using RRC signaling) to use a second value range of HPNs in unicast mode. The first value range and the second value range are different. In some embodiments, each value of the second value range of HPNs is used to schedule a unicast downlink physical channel carrying a unicast TB. Each value of a remaining value range of HPNs is used to schedule a unicast downlink physical channel carrying a multicast TB. The second value range and the remaining value range are different. The remaining value range corresponds to the first value range.

In some embodiments, according to the fourth indication method, the indication information is a HPN used in a multicast downlink control channel for scheduling the second TB. A unicast downlink control channel is used by the network to schedule the first TB in a unicast downlink shared channel. The unicast downlink control channel comprises the indication information and a multicast indication field. The multicast indication field indicates to the UE that the unicast downlink control channel is used to schedule a multicast TB or a unicast TB.

FIG. 8 is a flowchart diagram illustrating a wireless communication method 800 for managing multicast feedback, according to some embodiments of the present disclosure. Referring to FIGS. 1-8, the wireless communication method 800 can be implemented by a network (e.g., one or more base stations or network nodes). The method 800 corresponds to the UE-implemented method 700.

At 810, the network transmits to a UE, a first TB and indication information. The first TB is transmitted via unicast. At 820, the network transmits to a plurality of UEs, a second TB via multicast. The plurality of UEs includes the UE. The indication information indicates that the first TB transmitted via the unicast is same as the second TB transmitted by the network via the multicast. In some examples, the first TB and the indication information are transmitted before the second TB. In some examples, the first TB and the indication information are transmitted after the second TB, as shown in FIGS. 2-6.

In some embodiments, the UE refrains from providing negative feedback to the network. The negative feedback indicates to the network that the UE has failed to correctly receive the second TB via the multicast. In some embodiments, the first TB and the second TB are the same. The negative feedback is a NACK feedback.

In some embodiments, according to the first indication method, the indication information is a HPN used in a multicast downlink control channel for scheduling the second TB. The first TB is transmitted in a unicast downlink shared channel of the unicast. A unicast downlink control channel is used to schedule the first TB in a unicast downlink shared channel.

In some embodiments, according to the first indication method, the indication information is transmitted by the network via signaling on a unicast downlink shared channel scheduled by a unicast downlink control channel. As disclosed in further detail herein, a time interval between an ending point (e.g., an end of a last symbol) of the unicast downlink shared channel and a starting point (e.g., a start symbol) of a feedback resource corresponding to the second TB is greater than a threshold.

In some embodiments, according to the first, second, third, or fourth indication method, the indication information is transmitted by the network to the UE in a unicast downlink control channel used to schedule the first TB in a unicast downlink shared channel. As disclosed in further detail herein, a time interval between an ending point (e.g., an end of a last symbol) of a CORESET for the unicast downlink control channel and a starting point (e.g., a start symbol) of a feedback resource corresponding to the second TB is greater than a threshold.

In some embodiments, according to the second indication method, the indication information is a HPN used in a multicast downlink control channel for scheduling the second TB. The multicast downlink control channel is defined to use a first value range of HPNs in multicast mode. A unicast downlink control channel is defined to use a second value range of HPNs in unicast mode. The first value range is a subset of the second value range. In some examples, each value of a first portion of the second value range of HPNs is used to schedule a unicast downlink physical channel carrying a multicast TB. Each value of a second portion of the second value range of HPNs is used to schedule a unicast downlink physical channel carrying a unicast TB.

In some embodiments, according to the third indication method, the indication information is a HPN used in a multicast downlink control channel for scheduling the second TB. The multicast downlink control channel is defined to use a first value range of HPNs in multicast mode. A unicast downlink control channel is defined to use a second value range of HPNs in unicast mode. The first value range and the second value range are different. In some examples, each value of the second value range of HPNs is used to schedule a unicast downlink physical channel carrying a unicast TB. Each value of a remaining value range of HPNs is used to schedule a unicast downlink physical channel carrying a multicast TB. The second value range and the remaining value range are different. The remaining value range corresponds to the first value range.

In some embodiments, according to the fourth indication method, the indication information is a HPN used in a multicast downlink control channel for scheduling the second TB. A unicast downlink control channel is used by the network to schedule the first TB in a unicast downlink shared channel. The unicast downlink control channel comprises the indication information and a multicast indication field. The multicast indication field indicates to the UE that the unicast downlink control channel is used to schedule a multicast TB or a unicast TB.

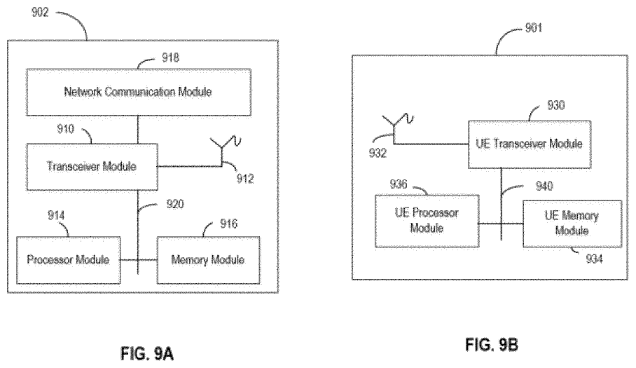

FIG. 9A illustrates a block diagram of an example base station 902 (e.g., a communication node, a network node, and so on), in accordance with some embodiments of the present disclosure. FIG. 9B illustrates a block diagram of an example UE 901, in accordance with some embodiments of the present disclosure. Referring to FIGS. 1-9B, the UE 901 (e.g., a wireless communication device, a terminal, a mobile device, a mobile user, and so on) is an example implementation of the UEs described herein, and the base station 902 is an example implementation of the base station described herein. In particular, the UE 901 and the base station 902 can respectively perform the methods 700 and 800, as described herein.

The base station 902 and the UE 901 can include components and elements configured to support known or conventional operating features that need not be described in detail herein. In one illustrative embodiment, the base station 902 and the UE 901 can be used to communicate (e.g., transmit and receive) data symbols in a wireless communication environment, as described above. For instance, the base station 902 can be a base station (e.g., gNB, eNB, and so on), a server, a node, or any suitable computing device used to implement various network functions.

The base station 902 includes a transceiver module 910, an antenna 912, a processor module 914, a memory module 916, and a network communication module 918. The module 910, 912, 914, 916, and 918 are operatively coupled to and interconnected with one another via a data communication bus 920. The UE 901 includes a UE transceiver module 930, a UE antenna 932, a UE memory module 934, and a UE processor module 936. The modules 930, 932, 934, and 936 are operatively coupled to and interconnected with one another via a data communication bus 940. The base station 902 communicates with the UE 901 or another base station via a communication channel, which can be any wireless channel or other medium suitable for transmission of data as described herein.

As would be understood by persons of ordinary skill in the art, the base station 902 and the UE 901 can further include any number of modules other than the modules shown in FIGS. 9A and 9B. The various illustrative blocks, modules, circuits, and processing logic described in connection with the embodiments disclosed herein can be implemented in hardware, computer-readable software, firmware, or any practical combination thereof. To illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. The embodiments described herein can be implemented in a suitable manner for each particular application, but any implementation decisions should not be interpreted as limiting the scope of the present disclosure.

In accordance with some embodiments, the UE transceiver 930 includes a radio frequency (RF) transmitter and a RF receiver each including circuitry that is coupled to the antenna 932. A duplex switch (not shown) may alternatively couple the RF transmitter or receiver to the antenna in time duplex fashion. Similarly, in accordance with some embodiments, the transceiver 910 includes an RF transmitter and a RF receiver each having circuity that is coupled to the antenna 912 or the antenna of another base station. A duplex switch may alternatively couple the RF transmitter or receiver to the antenna 912 in time duplex fashion. The operations of the two-transceiver modules 910 and 930 can be coordinated in time such that the receiver circuitry is coupled to the antenna 932 for reception of transmissions over a wireless transmission link at the same time that the transmitter is coupled to the antenna 912. In some embodiments, there is close time synchronization with a minimal guard time between changes in duplex direction.

The UE transceiver 930 and the transceiver 910 are configured to communicate via the wireless data communication link, and cooperate with a suitably configured RF antenna arrangement 912/932 that can support a particular wireless communication protocol and modulation scheme. In some illustrative embodiments, the UE transceiver 910 and the transceiver 910 are configured to support industry standards such as the Long Term Evolution (LTE) and emerging 5G standards, and the like. It is understood, however, that the present disclosure is not necessarily limited in application to a particular standard and associated protocols. Rather, the UE transceiver 930 and the base station transceiver 910 may be configured to support alternate, or additional, wireless data communication protocols, including future standards or variations thereof.

The transceiver 910 and the transceiver of another base station (such as but not limited to, the transceiver 910) are configured to communicate via a wireless data communication link, and cooperate with a suitably configured RF antenna arrangement that can support a particular wireless communication protocol and modulation scheme. In some illustrative embodiments, the transceiver 910 and the transceiver of another base station are configured to support industry standards such as the LTE and emerging 5G standards, and the like. It is understood, however, that the present disclosure is not necessarily limited in application to a particular standard and associated protocols. Rather, the transceiver 910 and the transceiver of another base station may be configured to support alternate, or additional, wireless data communication protocols, including future standards or variations thereof.

In accordance with various embodiments, the base station 902 may be a base station such as but not limited to, an eNB, a serving eNB, a target eNB, a femto station, or a pico station, for example. The base station 902 can be an RN, a regular, a DeNB, or a gNB. In some embodiments, the UE 901 may be embodied in various types of user devices such as a mobile phone, a smart phone, a personal digital assistant (PDA), tablet, laptop computer, wearable computing device, etc. The processor modules 914 and 936 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the method or algorithm disclosed herein can be embodied directly in hardware, in firmware, in a software module executed by processor modules 914 and 936, respectively, or in any practical combination thereof. The memory modules 916 and 934 may be realized as RAM memory, flash memory, ROM memory, EPROM memory, EEPROM memory, registers, a hard disk, a removable disk, a CD-ROM, or any other form of storage medium known in the art. In this regard, memory modules 916 and 934 may be coupled to the processor modules 910 and 930, respectively, such that the processors modules 910 and 930 can read information from, and write information to, memory modules 916 and 934, respectively. The memory modules 916 and 934 may also be integrated into their respective processor modules 910 and 930. In some embodiments, the memory modules 916 and 934 may each include a cache memory for storing temporary variables or other intermediate information during execution of instructions to be executed by processor modules 910 and 930, respectively. Memory modules 916 and 934 may also each include non-volatile memory for storing instructions to be executed by the processor modules 910 and 930, respectively.

The network communication module 918 generally represents the hardware, software, firmware, processing logic, and/or other components of the base station 902 that enable bi-directional communication between the transceiver 910 and other network components and communication nodes in communication with the base station 902. For example, the network communication module 918 may be configured to support interne or WiMAX traffic. In a deployment, without limitation, the network communication module 918 provides an 802.3 Ethernet interface such that the transceiver 910 can communicate with a conventional Ethernet based computer network. In this manner, the network communication module 918 may include a physical interface for connection to the computer network (e.g., Mobile Switching Center (MSC)). In some embodiments, the network communication module 918 includes a fiber transport connection configured to connect the base station 902 to a core network. The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program (e.g., a computer program product) or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A wireless communication method, comprising:
receiving, by a wireless communication device from a network, a first Transport Block (TB) via unicast; and
receiving, by the wireless communication device from the network, an indication information indicating that the first TB received via the unicast is same as a second TB transmitted by the network via multicast.

2. The method of claim 1, in response to receiving the first TB and the indication information or in response to receiving the indication information, refraining, by the wireless communication device, from providing negative feedback to the network, wherein the negative feedback indicates to the network that the wireless communication device has failed to correctly receive the second TB via the multicast.

3. The method of claim 2, wherein
the first TB and the second TB are a same TB;
the negative feedback is a Negative Acknowledgement (NACK) feedback.

4. The method of claim 1, wherein
the indication information is a Hybrid Automatic Repeat Request (HARD) Processing Number (HPN) used in a multicast downlink control channel for scheduling the second TB.

5. The method of claim 1, wherein the indication information is received from the network via signaling on a unicast downlink shared channel scheduled by a unicast downlink control channel.

6. The method of claim 5, wherein a time interval between an ending point of the unicast downlink shared channel and a starting point of a feedback resource corresponding to the second TB is greater than a threshold.

7. The method of claim 1, wherein the indication information is received from the network in a unicast downlink control channel used to schedule the first TB in a unicast downlink shared channel.

8. The method of claim 7, wherein a time interval between an ending point of a Control Resource Set (CORESET) for the unicast downlink control channel and a starting point of a feedback resource corresponding to the second TB is greater than a threshold.

9. The method of claim 1, wherein
the indication information is a Hybrid Automatic Repeat Request (HARQ) Processing Number (HPN) used in a multicast downlink control channel for scheduling the second TB;
the multicast downlink control channel is defined to use a first value range of HPNs;
a unicast downlink control channel is defined to use a second value range of HPNs; and
the first value range is a subset of the second value range.

10. The method of claim 9, wherein
each value of a first portion of the second value range of HPNs is used to schedule a unicast downlink physical channel carrying a multicast TB; and
each value of a second portion of the second value range of HPNs is used to schedule a unicast downlink physical channel carrying a unicast TB; and
the first portion of the second value range corresponds to the first value range.

11. The method of claim 1, wherein
the indication information is a Hybrid Automatic Repeat Request (HARQ) Processing Number (HPN) used in a multicast downlink control channel for scheduling the second TB;
the multicast downlink control channel is defined to use a first value range of HPNs in multicast mode;
a unicast downlink control channel is defined to use a second value range of HPNs in unicast mode; and
the first value range and the second value range are different.

12. The method of claim 11, wherein
each value of the second value range of HPNs is used to schedule a unicast downlink physical channel carrying a unicast TB;
each value of a remaining value range of HPNs is used to schedule a unicast downlink physical channel carrying a multicast TB;
the second value range and the remaining value range are different; and
the remaining value range corresponds to the first value range.

13. The method of claim 1, wherein
the indication information is a Hybrid Automatic Repeat Request (HARD) Processing Number (HPN) used in a multicast downlink control channel for scheduling the second TB;
a unicast downlink control channel is used by the network to schedule the first TB in a unicast downlink shared channel;
the unicast downlink control channel comprises the indication information and a multicast indication field; and
the multicast indication field indicates to the wireless communication device that the unicast downlink control channel is used to schedule a multicast TB or a unicast TB.

14. A wireless communication device, comprising:
at least one processor configured to:
receive, via a receiver from a network, a first Transport Block (TB) via unicast; and
receive, via the receiver from the network, an indication information indicating that the first TB received via the unicast is same as a second TB transmitted by the network via multicast.

15. A network node, comprising:
at least one processor configured to:
transmit, via a transmitter to a wireless communication device, a first Transport Block (TB) via unicast and indication information; and
transmit, via the transmitter to a plurality of wireless communication devices, a second TB via multicast, wherein the plurality of wireless communication devices comprises the wireless communication device, and the indication information indicates that the first TB transmitted via the unicast is same as the second TB transmitted by the network via the multicast.

16. A wireless communication method, comprising:
transmitting, by a network to a wireless communication device, a first Transport Block (TB) via unicast and indication information; and
transmitting, by the network to a plurality of wireless communication devices, a second TB via multicast, wherein the plurality of wireless communication devices comprises the wireless communication device, and the indication information indicates that the first TB transmitted via the unicast is same as the second TB transmitted by the network via the multicast.

17. The method of claim 16, wherein the wireless communication device refrains from providing negative feedback to the network, wherein the negative feedback indicates to the network that the wireless communication device has failed to correctly receive the second TB via the multicast.

18. The method of claim 17, wherein
the first TB and the second TB are the same;
the negative feedback is a Negative Acknowledgement (NACK) feedback.

19. The method of claim 16, wherein the indication information is a Hybrid Automatic Repeat Request (HARD) Processing Number (HPN) used in a multicast downlink control channel for scheduling the second TB.

20. The method of claim 16, wherein the indication information is transmitted by the network via signaling on a unicast downlink shared channel scheduled by a unicast downlink control channel.
